(19) United States
(12) Patent Application Publication
(10) Pub. No.: US 2020/0158681 A1
(43) Pub. Date: May 21, 2020

(54) Detection of Disease or Pathogen Related Enzymes Using Ferrocene Sensor Modified Electrodes

(71) Applicant: Texas Christian University, Fort Worth, TX (US)

(72) Inventors: Kayla N. Green, Fort Worth, TX (US); Marianne E. Burnett, Hurst, TX (US); Sean M. Rodich, Wilsonville, OR (US)

(73) Assignee: Texas Christian University, Fort Worth, TX (US)

(21) Appl. No.: 16/676,707

(22) Filed: Nov. 7, 2019

Related U.S. Application Data
(60) Provisional application No. 62/769,061, filed on Nov. 19, 2018.

(51) Int. Cl. G01N 27/327; G01N 27/48

(52) U.S. Cl. CPC G01N 27/3277; G01N 27/48

(57) ABSTRACT

A method for detection of disease or pathogen related enzymes is shown using new electrochemical biosensors that are responsive to the reactivity of enzymes. Three components are involved: (1) a simple linker for attachment to electrode surfaces; (2) the ferrocene signal unit; and (3) a substrate that can be removed from the ferrocene molecule by enzyme activity. The highly reversible Fe^{2+/3+} redox couple of ferrocene is used as the electrochemical signal. A substrate is covalently attached to the ferrocene molecule that is selectively targeted and known to be cleaved by the enzyme analyte of interest. The enzyme activity removes the substrate from the ferrocene molecule, producing a new ferrocene molecule with a new redox potential compared to the parent ferrocene-substrate molecule which enables enzyme concentrations associated with disease or pathogens to be quantified.

### CROSS REFERENCE TO RELATED APPLICATIONS

The present application claims priority from a provisional application Ser. No. 62/769,061, filed Nov. 19, 2018, entitled “Detection of Disease or Pathogen Related Enzymes Using Ferrocene Sensor Modified Electrodes,” by the same inventors.

### BACKGROUND OF THE INVENTION

### Field of the Invention

The present invention relates generally to the development of electrochemical biosensors that are responsive by a change in potential (mV) to the reactivity of enzymes and the use of such biosensors for the detection of disease or pathogens, particularly where the biosensor is a ferrocene sensor modified electrode.

### Description of the Prior Art

Infectious disease remains one of the leading causes of death worldwide. As a result, new methods of diagnosing disease and measuring pathogens are constantly needed. Electrochemical biosensors offer advantages to other methods of measurement. Current methods of detection and quantification include immunohistochemistry, ELISA assays, radioimmunoassays, mass spectrometry, and western blot analysis. However drawbacks to the use of these methods include labor intensiveness, the requirement of highly trained personnel, lengthy work-up and analysis, and high cost due to supplies and advanced instrumentation. These factors have hindered their implementation into widespread clinical use. Other analytical methods such as fluorescence imaging have also been explored but fluorogenic substrates and enzyme effectors are inherently a challenge to produce, face stability challenges, and/or are cost prohibitive for use on a commercial scale. Imaging techniques such as PET, CT, and MRI are excellent modalities for evaluating the structure of masses associated with diseases, in particular cancer. However, the instrumentation and toxicity derived from frequent use of contrast agents for imaging make frequent scans impossible. Biosensors have the potential to overcome these factors and complement the existing imaging modalities to provide a more comprehensive picture of disease.

Biosensors are small analytical devices that employ a biological recognition moiety coupled to a physical transducer of signal. Electrochemical biosensors are at the forefront of this field due to their simplicity and cost effectiveness. The basic design of electrochemical biosensors centers on an electrode equipped with a recognition molecule specific for the biological marker of interest and a signal transduction element. The action of the biomarker interacting with the recognition component of the sensor results in a measurable change of potential (mV) or current (A) using electrochemical measurement methods. The measured changes enable quantitative or semi-quantitative analysis of the biomarker analyte. The best known examples of such devices are self-test glucometers, which have screen printed electrodes coated with glucose oxidase enzyme coupled to a pocket-size amperometer. An ideal biosensor is selective, rapid, portable, and requires minimal sample processing prior to analysis. Glucometer devices traditionally utilize a coulemetric method where the total amount of charge in the form of electrons generated by the glucose oxidation reaction is measured over a period of time. These monitoring devices have revolutionized the quality of life for diabetes patients by empowering patients to monitor the disease through an easy and rapid process.

The use of electrochemical based biosensors is very attractive for point-of-care diagnostics. Biosensor devices are self-contained, lightweight and portable and only require a battery for function unlike PCR, imaging, colorimetric, and other methods. The measurement results are obtained quickly and can even be sent directly to the user's personal mobile device or medical doctor for review using wireless technology. The qualities of electrochemical glucometer biosensors have given patients diagnosed with diabetes the unique ability to manage their disease. The cost effectiveness and case of glucometer production have elevated these devices to being accessible worldwide.

The development of biosensors for other diseases or pathogens have the potential to revolutionize clinical medicine. Critical information about disease or pathogen levels would be readily available through the use of biosensors that provide rapid, cost-effective methods of detection or monitoring.

Similarly, the development of small, low molecular weight sensors for quantification of cancer biomarkers in solution could revolutionize the detection and treatment of cancer, improving the survival chances of countless patients.

As an example of this, some development of electrochemical techniques using technology similar to glucometer's has been done to detect and quantify caspase-3, a biomarker for cancer. Xiao and co-workers developed a ferrocene-based electrochemical biosensor for caspase-3 detection. An “on-off” sensor was developed by immobilizing a cysteine terminated Asp-Glu-Val-Asp (or, DEVD) substrate to a gold electrode surface. On the C-terminus of the DEVD sequence, a ferrocene (Fc) molecule was covalently attached as the electroactive center necessary for signal detection. Upon addition of caspase-3 to the biosensor, the signal is “turned off” by cleavage of the Fc-DEVD moiety resulting in the electroactive group diffusing away from the electrode surface. Although this study showed the promise in development of a caspase-3 electrochemical sensor, experimental conditions (1 M HClO₄, time >0.5 h) were not conducive for clinical applications and the “on-off” nature of the sensor has the potential to lead to false negatives and positives.

Another example of using electrochemical techniques to detect and quantify caspase-3 can be seen in work done by Zhang and co-workers. Zhang's work focused on the utilization of quantum dots for signal amplification using anodic stripping voltammetry (ASV). Specifically, a biotinylated peptide was designed with a biotin moiety on the N-terminus of the DEVD substrate with a terminal cysteine residue on the C-terminus of the substrate. Upon introduction of caspase-3, the biotinylated substrate diffuses away from the gold surface. The gold surface is then incubated with modified carbon nanotubes (CNTs) fabricated with CdTe quantum dots and streptavidin (CNTs-QDs-SA). Quantification of DEVD substrate remaining on the surface is evaluated by streptavidin-biotin interaction. The CNTs-QDs-SA now attached to the surface were removed by dissolving the nanotubes in nitric acid (HNO3, 0.1 M). The electrochemical signal was obtained using ASV focusing on the well-defined oxidation for Cd. Although the use of CNTs-QDs provides a route for signal amplification using ASV, reagents used, including HNO₃, are harsh, especially for the clinic. In addition, this particular sensor system still relies on an “on-off” type mechanism where the signal intensity decreases as a result of caspase-3 cleavage.

Building upon the methodology established by Zhang and co-workers, Khalilzadeh and researchers also developed an electrochemical biosensor for caspase-3 detection using horseradish peroxidase (HRP), streptavidin coated magnetic beads (MBs), and a DEVD substrate. To a clean gold surface, biotinylated DEVD modified peptide was immobilized onto the gold electrode a surface co-incubated with 6-mercaptohexanol. Then, streptavidin coated magnetic beads were incubated with the modified electrode surface followed by incubated with biotinylated HRP. The electrochemical signal is achieved after adding hydroquinone (HQ) and H₂O₂ and is observed using cyclic voltammetry and square wave voltammetry. Upon introduction of caspase-3, the DEVD-MB-HRP is cleaved from the surface of the electrode. A current depletion is observed as concentration of caspase increases. Incubation time of the modified electrodes in caspase-3 were kept constant at 1 h with an overall limit of detection of 100 pM. As with the other electrochemical biosensors for caspase-3, experimental disadvantages still remain, specifically the “on-off” type of sensing mechanism and increased incubation time.

The present invention presents the possibility of revolutionizing electrochemical techniques to detect caspase-3, as well as a myriad of other biomarkers for other types of infectious diseases, extending this type of capacity to other arenas involving exposure to pathogens or detection or management of other disease states. The herein described sensors are also designed to be adaptable to current glucometer devices or microfluidic arrays.

### SUMMARY OF THE INVENTION

Enzyme levels play a significant role in disease or pathogen detection. Currently there exists a need for a sensitive, efficient, reliable and cost-effective method to develop electrochemical biosensors that are responsive to the reactivity of enzymes. Although there already exist methods for detecting diseases and measuring pathogens, there is an unmet need for a novel method to detect disease or pathogen related enzymes using electrochemical biosensors. The present invention accordingly concerns the development of electrochemical biosensors that are responsive to the reactivity of enzymes. These electrochemical biosensors can also be used to detect pathogens in food, water, or other resources where pathogens are known to affect human health. The work described herein demonstrates that ferrocene sensor molecules can be responsive to target enzymes and provide dramatic shifts (>40 mV) in redox potentials, which is previously unprecedented.

The particularly preferred biosensors described in the discussion which follows have three components: (1) a linker for attachment to electrode surfaces; (2) the ferrocene signal unit; and (3) a substrate that can be removed from the ferrocene molecule. The highly reversible Fe^{2+/3+} redox couple of ferrocene is used as an electrochemical signal. The overall simple design is a significant departure from the current approaches that use complex biological components such as large peptides, RNA/DNA, or even enzymes as part of the biosensor itself. The new design avoids signal loss, instability problems and is easily adaptable to new analytes of interest.

In one preferred form, the optimized biosensors of the invention can be used to quantify a specific analyte using a receptor-substrate interaction. Many of the current biosensors utilize an “on-off” mechanism which focuses on the depletion of a signal, such as current, upon interaction of the receptor with a substrate. The present inventive method, on the other hand, utilizes an observable shift in signal, referred to herein as an “on-on” mechanism. The inventive method, to be further described hereafter, involves unique enzyme-responsive systems. For example, one system to be described uses a DEVD substrate with a ferrocene core to quantify caspase-3 in solution. All of the inventive systems to be described focus on the ability to use small, low molecular weight biosensors for quantification of cancer or other disease biomarkers in solution, or for the detection of other harmful pathogens.

In particular, a method is described herein for detecting disease or pathogen related enzymes using electrochemical biosensors, the method comprising the steps of:

using a receptor-substrate interaction of a biosensor to provide quantifiable information about a specific analyte,

wherein the receptor-substrate interaction produces an electrical signal induced using electrochemical methods in the form of an observable shift in redox potential, rather than the depletion of a signal, such as current, upon interaction of the receptor with the substrate;

wherein the electrical signal so produced which is induced using electrochemical means is used to provide quantification of disease or pathogen biomarkers in solution.

As mentioned, a DEVD substrate with a ferrocene core has been used to quantify caspase-3 enzyme in solution. The caspase-3 enzyme sensor produces dramatic shifts in redox potentials. In one case, a >300 mV shifts in redox potential was produced by enzyme action of the ferrocene sensor molecule tagged with a substrate specific for caspase-3 enzyme.

The ferrocene molecule is thus tagged with a substrate specific for a particular enzyme and is used as a sensor electrode which targets the specific enzyme associated with disease or pathogens. The enzymes used can by any of those the presence of which or expression of which is recognized as a marker for pathogens or indication of disease. The specific enzyme can be selected, for example, from the group consisting of caspase-3, β-galactosidase, MMP-2, trypsin and chymotrypsin, for example, all of which have the potential to function in this manner.

The ferrocene molecule which is tagged with the substrate comprises a bioconjugate. The selected enzyme has the ability to consume the ferrocene substrate bioconjugate to produce a new ferrocene molecule which has a new, detectable and measurable electrochemical signal. The ferrocene substrate bioconjugates are responsive to target selected enzymes to provide dramatic shifts in redox potentials.

In one sense, the preferred method for detecting disease or pathogen related enzymes using electrochemical biosensors includes the steps of:

providing an optimized biosensor which has the ability to quantify a specific enzyme analyte using a receptor-substrate interaction and an on-on observable detection mechanism, rather than the depletion of a signal, such as current, as the detection mechanism, the on-on detection mechanism producing a measurable shift in redox potential which can be measured with electrochemical analytical methods, including cyclic voltammetry; and
wherein the measurements so obtained from such electrochemical analytical methods are used to provide quantified information which can be used for disease or pathogen detection in a human body.

The methodology of the present invention offers numerous advantages over the existing state of the art including:

Small sample volume;
Little to no sample preparation;
Short analysis time;
High sensitivity;
Simple design (no complex proteins, DNA, RNA);
Low cost due to simplicity and setup;
Enzyme specific;
Easily multiplexed for detection of multiple enzymes/targets; and
Utilization of a new detection method; i.e., a new signal compared to a non-reacted sensor (not turn off).

Additional objects, features and advantages will be apparent in the written description which follows.

### BRIEF DESCRIPTION OF THE DRAWINGS

FIG. 1 is a pictorial representation of the principle behind the present invention showing cyclic voltammetries which compare the electrochemistry of a first compound and its product compound, showing a large shift in potentials;

FIG. 2 is pictorial representation of the prior art “turn-off” sensors of the type discussed herein;

FIG. 3 shows the structural formulas of various ferrocene bioconjugates which were modeled to and used in the studies described herein;

FIG. 4(a) is the SEM of a clean electrode used to make a gold ball electrode;

FIG. 4(b) is an AFM image of the clean electrode;

FIG. 4(c) is the AFM image of a modified electrode used in the practice of the present invention;

FIG. 4(d) is a cyclic voltammogram resulting from the immobilization of the clean electrode of FIG. 4(b) on the gold ball electrode;

FIG. 5 is a structural representation of the deposition of amine based bioconjugate onto a graphite electrode;

FIG. 6 is a simplified structural representation of the enzymatic products of β-galactosidase targeting Fc-bioconjugates, illustrating the reaction with target enzymes which produces a new molecule with different electrochemical features than the precursor;

### DETAILED DESCRIPTION OF THE INVENTION

While the process of making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but such usage is not intended to delimit the invention, except as outlined in the claims.

### Specific Aim and Significance:

Enzymes are critical components of molecular biology responsible for molecular transformations and present a unique target to measure. Many enzymes are manufactured based on the needs of the organism. For example, the concentration of the team of antioxidant enzymes that regulate oxidative stress increase in concentration when cells are exposed to oxidative stress. Likewise, enzyme levels change with disease. For example, the team of enzymes known to mediate oxidative stress is reduced in patients afflicted with Alzheimer's disease. In another example, copper-based SOD enzymes are found to be abnormal in ALS patients. Enzymes serve as a direct measure of the chemical biology occurring in an organism. Therefore, the development of methods that can detect and quantify enzymes would provide a direct measure of disease. Moreover, the same strategy could be applied to detecting dangerous pathogens in water or food sources by measuring the enzymes that they produce. Enzymes can be thought of as reactive biomarkers. The reactivity is a unique quality that can be harnessed to trigger the measurements carried out by simple ferrocene sensor molecules.

The present invention includes compositions and methods for making and using a new class of electrochemical biosensors used in the diagnosis of disease and measurement of pathogens using enzyme responsive systems. Thus, biomarkers, such as enzymes, can now be specifically linked to disease states and pathogens. Enzymes now serve as targets for the detection of disease at an early stage or can be used to prevent human exposure to pathogenic species. However, the development of easy to use, fast, and cost-effective analytical methods of detecting disease or pathogens is still a great need. Electrochemical biosensors can offer features that meet these demands. While enzymes have been incorporated as a functioning component of electrochemical biosensor devices, the use of an enzyme for detection of a disease or pathogen has not been fully explored. The present invention uses the reactivity of enzymes as a mechanism to trigger electrochemical changes resulting from chemical modifications to ferrocene sensor immobilized electrodes.

The present sensor design is unique because the ferrocene molecules are simple and will remain immobilized on the electrode surface while the enzyme reactivity will be used to create a new ferrocene molecule by consuming the substrate. This design avoids complex methods of electrode adhesion and utilizes fundamental electrochemical and chemistry concepts to achieve a large change in ferrocene redox potentials. As has been mentioned, results have been obtained showing that a caspase-3 enzyme sensor will produce >300 mV shifts in redox potentials by enzyme action of the ferrocene sensor molecule tagged with a substrate specific for caspase-3 enzyme. The inventive method focuses on the development of ferrocene-based molecules that function as electrochemical measurement systems capable of quantifying enzyme concentrations. Accordingly, one object of the invention is to accomplish the following Specific Aims to develop ferrocene sensor electrodes targeting five enzymes associated with diseases including cancer, neurodegeneration, and pathogens such as E. coli.

### Innovation

### Basle Design of Proposed Enzyme Responsive Small Molecules Unique.

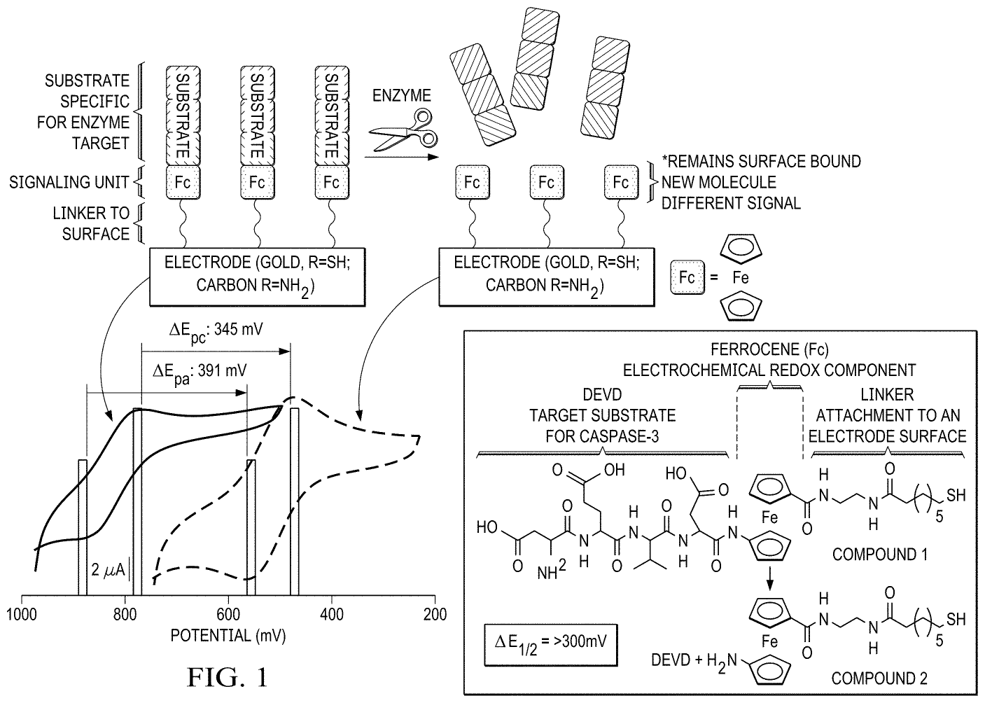

FIG. 1 is a simplified illustration of the principle behind the ferrocene sensor electrodes used in the practice of the invention. The electrochemical data shown are recent results comparing the electrochemistry of compound 1 and its product compound 2, which have a large difference in potential values (mV). The DEVD component of compound 1 is cleaved by caspase, yielding compound 2 and results in large shifts in the reduction (−345 mV) and oxidation (−391 mV) potentials compared to the starting sensor 1. Fc=ferrocene. The biosensors of the invention have three components which, as shown in FIG. 1, are: (1) a simple aliphatic linker for attachment to electrode surfaces, (2) the ferrocene signal unit, and (3) substrates that can be removed from the ferrocene molecule by enzyme activity. A broad range of substrates may be utilized. The highly reversible Fe²⁺ to Fe³⁺ redox couple of ferrocene is used as the electrochemical signal. The specific redox potential (measured in mV) at which this occurs is controlled by the chemical substitution on the cyclopentadienyl ring of the ferrocene molecule. As shown in FIG. 1, simple changes induced by enzyme reactivity result in dramatic changes in Fe^{2+/3+} potential values. In the process of the invention, a substrate is covalently attached to the ferrocene molecule that is selectively targeted and known to be cleaved by the enzyme analyte of interest (see Table 1 later in the discussion). The enzyme activity will remove the substrate from the ferrocene molecule. This reactivity produces a new ferrocene molecule with a new redox potential compared to the parent ferrocene-substrate molecule. Results to date indicate that shifts on the order of 300 mV, and greater, in potential are readily achieved. Through calibration it will be possible to provide shift/unit of analyte for quantification.

### Comparison to Other Biosensor Designs Show Opportunity for Innovation.

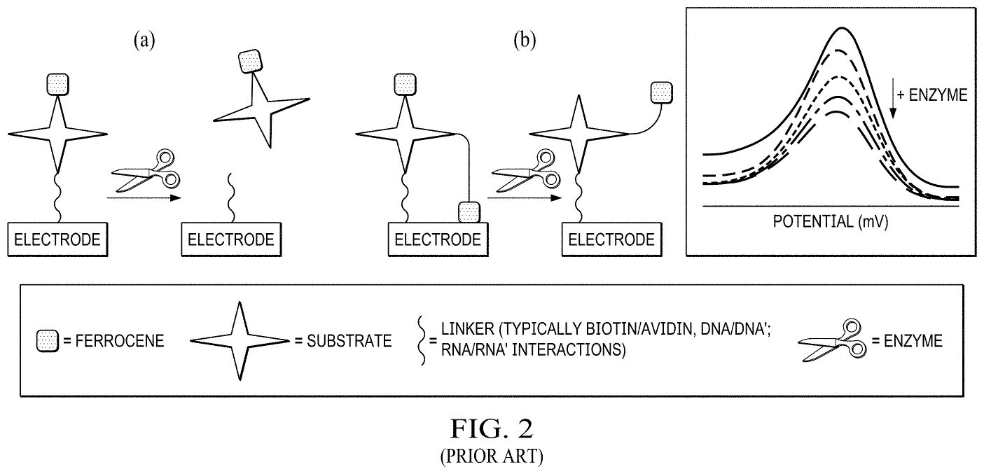

The following discussion will highlight opportunities in which current tactics to biosensor design can be improved using the approach of the invention. There are a range of approaches currently reported for biosensors specific to the detection of biomarkers, including enzymes. The vast majority of responsive biosensors use a change in current (amperage) as the means of quantifying an enzyme target. A majority of these systems are what will be referred to in this discussion as “turn-off” sensors. The general idea of a turn-off sensor is shown in FIG. 2 where in example (a) enzyme activity cleaves the substrate+ferrocene from the electrode. In example (b), the distance between the ferrocene and the electrode is increased by enzyme activity on the substrate. Diffusion of the ferrocene molecule away from the electrode surface results in a decrease in electrical signal in both examples (a) and (b).

Thus, in the “turn-off” system illustrated in FIG. 2, the action of the biomarker (enzyme) of interest with the sensor results in the ferrocene unit being chemically removed from the electrode or the distance increases. Either mechanism results in a signal decrease which can be used to quantify the analyte of interest. A decrease in signal intensity is not ideal as it severely impedes the limits of detection. Other popular immobilized biosensors function on the premise of measuring changes in impedance that occur when a target biomolecule interacts with the biosensor. These changes can be caused by a number of factors that include variations in solution resistance and double layer capacitance. These factors are independent of the target-receptor binding event but are challenging to differentiate from the binding interaction itself. As an alternative to the two types of sensors described above and other approaches, the present inventive method utilizes a change in the redox potential (mV) of the redox tag to provide a preferential method of detection. A number of advantages will result including the following:

1) The ferrocene signal unit is in close proximity to the electrode surface. This interaction is designed to (a) provide a strong electrochemical signal and (b) remain intact following the action of the enzyme.

2) The sensor molecules are designed to take advantage of the enzyme activity to produce drastic changes in the potential of the ferrocene molecule (not “turn-off”).

3) Both changes in current (A) and potential (mV) will serve as measurable readouts for quantifying enzyme concentration which should produce an increase in the accuracy with two concurrent read-outs,

4) The ability to integrate these small molecules onto screen printed electrodes (SPE) or microfluidic arrays make the use of glucometer type technology a reasonable outgrowth of this work.

Many biosensors function through the use of biological components as a part of the biosensor unit itself. In fact, glucometers use the redox chemistry involved with immobilized glucose oxidase enzymes as a readout for the concentration of glucose in blood. Biological components including biotin-avidin or RNA/RNA′, DNA/DNA′ interactions are used as linker strategies for actually attaching the sensor systems to electrode surfaces. One drawback to using enzymes, antibodies, DNA, and RNA as a functional component of the biosensor itself is that these are time consuming to produce and unstable. Glucose test strips have a limited shelf life of six months for this reason.

The principles of the present inventive method provide the advantages of avoiding complicated biological components by using a simple, chemistry based approach using simple ferrocene-bioconjugates that are composed of (1) a simple aliphatic linker for surface attachment, (2) the ferrocene signal unit, and (3) simple substrates that can be removed from the ferrocene molecule by enzyme activity. These molecules are easy and cost effective to produce, characterize, and are stable indefinitely.

### Details of how the Responsive Biosensors of the Invention Will Work

Without wishing to be bound by any particular theory, the principles of the present invention can be roughly analogized in terms of MRI contrast agents. MRI contrast agents have similarities that parallel the same negative features associated with typical biosensors described above. Many MRI contrast agents are negative agents (‘turn-off’) that result in a darkening of tissue in an MRI image as opposed to brightening which would provide enhanced definition of structural features. Moreover, MRI agents are still suffering from a lack of specificity for specific targets or tissue of interest. However, and very recently, a small library of MRI contrast agents has been designed to ‘turn-on’ when acted upon by enzymes. The enzymatic activity modifies the structure of the contrast agent, often irreversibly, to produce a new MRI signal. These agents are thus termed “responsive MRI contrast agents.” The specificity of these imaging agents makes them attractive for use in clinical diseases exhibiting the up regulation of biomolecules such as enzymes. The present inventive concept may be thought of as marrying the construct utilized by responsive MRI contrast agents with biosensor technology. That is, enzyme concentrations associated with disease or pathogens will be quantified by taking advantage of the activity of the enzyme itself. This idea is depicted in FIG. 1, which shows a generic enzyme substrate is cleaved from the redox ferrocene tag. In the presence of the enzyme, the substrate would be consumed, while the sensor is converted into a new structure with different electrochemical properties. This modification will create a significant change in the measured potential of the Fe^{2+/3+} redox couple from the new ferrocene product. These ferrocene sensors molecules will be attached to an electrode solid support and/or nanomaterials.

Preliminary Results with Target 1: Caspase-3 Responsive Ferrocene Complexes.

The design of a caspase-3 ferrocene sensor molecule is central to the principles employed in the present inventive method. Caspase enzyme levels are linked to the recurrence of cancer. Diseases such as cancer are known pathways responsible for changes in enzyme concentrations within the human body, thereby providing a handle through which disease states can be monitored. An example of this occurs with caspase-3 in tumor cells. Caspases are a family of enzymes involved primarily in apoptosis, the body's most widely-used mechanism of programmed cell death. While this process is used by the immune system to selectively terminate infected cells around the body, it can be stimulated in specific areas through the use of radiation therapy. Apoptosis is stimulated in tumor and non-tumor cells alike by exposure to radiation. Cells in the radiated area(s) die. While this method of tumor treatment is successful, there are instances where surviving tumor cells are able to repopulate at an accelerated rate as a result of the radiation. This occurs because one of the downstream effectors of caspase-3 is the growth factor prostaglandin E₂. Under these circumstances, prostaglandin E₂ levels will be elevated and the cell is able to quickly repopulate if a tumor cell is able to survive the radiation exposure. This mechanism of repopulation is referred to as the “Phoenix Rising pathway” and can be used to explain why some patients suffer from a recurrence of cancerous tumor growth in a particular area after undergoing radiation therapy. Therefore, monitoring the levels of caspase in a patient during remission would provide an important method of curtailing a recurrence.

### Rationale for Caspase-3 Sensor Design.

The present method is thus based, in part, upon an interest in the previously described ferrocene sensor molecules and the Phoenix Rising Pathway, with an object being the production of a caspase-3 responsive ferrocene sensor. This system serves as a model to test the hypothesis that removal of the substrate from the ferrocene sensor molecule would provide significant changes to the Fe^{2+/3+} redox potential. The caspase-3 responsive molecule, compound 1 shown in FIG. 1, functions as a proof of concept The Asp-Glu-Val-Asp (DEVD) peptide is cleaved by the caspase-3 enzyme, an “executioner” of the metabolic death cascade during cell apoptosis. The protease mediated cleavage of the DEVD substrate occurs after the aspartic acid residue at the C-terminal side and is well characterized. Having a system that is clearly-developed in terms of enzyme activity and kinetics will be useful in troubleshooting design and detection issues that may arise in working with enzyme targets 1-5 and substrate Fc complexes, described below.

### Electrochemistry of Caspase-3 Sensor.

Compound 1 was produced in three days using solid phase methods and isolated in good yield (65%) as an orange solid. Compound 2 was also produced independently, because it is the expected product resulting from the reaction between caspase-3 and compound 1. The electrochemistry results of compounds 1 and 2 (reduction and oxidation) are shown in the inset of FIG. 1 which exemplifies the extreme changes that occur to the ferrocene Fe^{2+/3+} redox couple when the DEVD component is removed. This ΔE_{1/2}>300 mV shift in electrochemical potential between compound 1 and 2 is easily distinguishable, thus making quantification of enzyme straightforward. It will be observed that the addition of caspase-3 (0.8 ng/μL) to compound 1 immobilized on a gold electrode achieves the shift in potential demonstrated with compound 2. In addition, Atomic Force Microscopy (AFM) and cyclic voltammetry confirmed that compound 1 readily binds to both a gold screen printed electrode purchased from Dropsens as well as a gold ball electrode presumably through the well-documented Au—S interaction.

### Electrode Modification Provides Signal Stability and Portability.

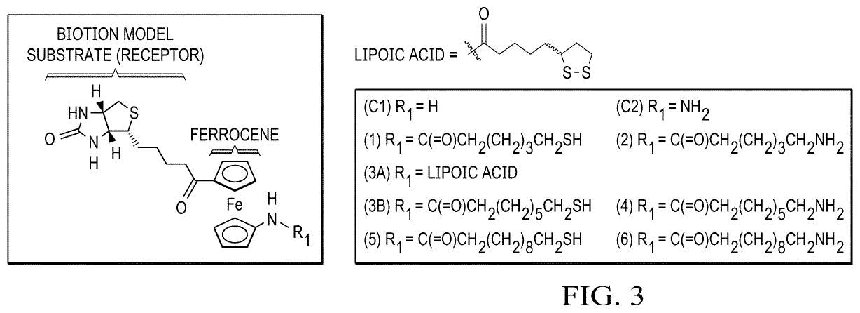

It has been demonstrated that ferrocene small molecules can be immobilized on gold electrodes and on graphite surfaces. Part of the focus of the present work has been on establishing optimized immobilization methods for ferrocene-based molecules of the type described. Molecules were used composed of biotin-ferrocene-linker to model a ferrocene bioconjugate applicable to the studies below. A total of nine biotin-ferrocene molecules were produced and are shown in FIG. 3. These molecules were used to evaluate linkers for immobilization.

### Method 1: Gold.

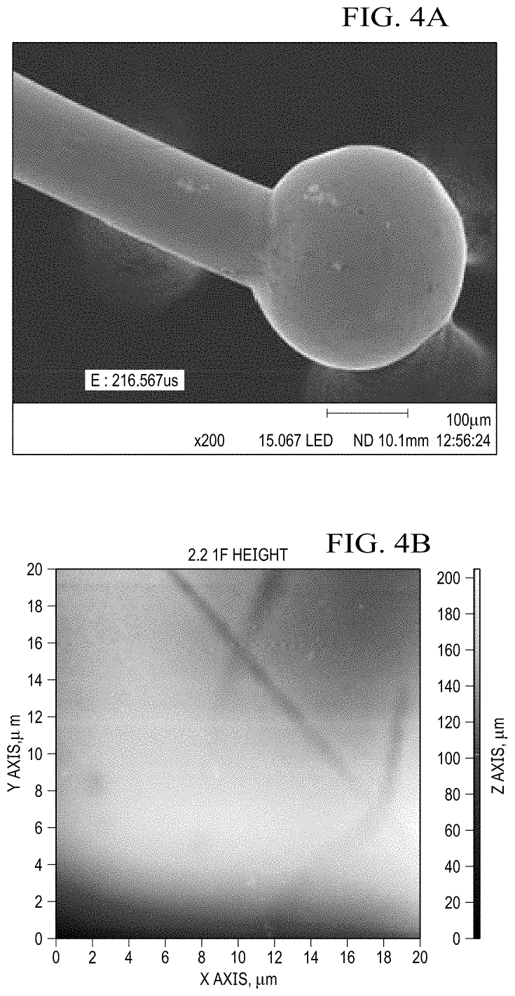

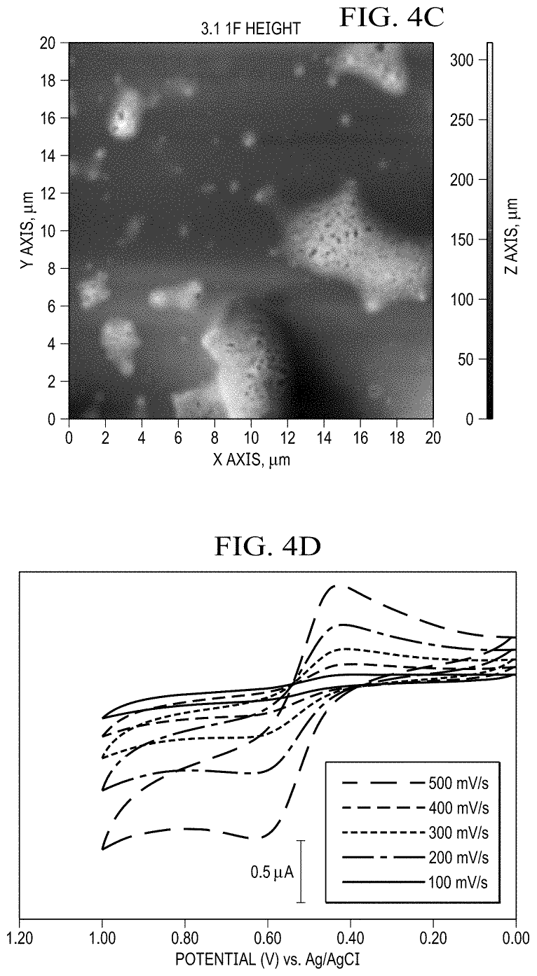

Thiolate terminated molecules 1,3A-B,5 were successfully immobilized on gold ball electrodes. Gold ball electrodes were produced using literature methods. Electrochemical stripping in acidic media was used to thoroughly clean the surface of each electrode. The electrodes were studied using electron microscopy which showed that the present techniques provided remarkably consistent shape and size, such as the example shown in FIGS. 4(a) to 4(d). Immobilization of 1,3A-B,5 was accomplished by incubation of the gold ball electrode with molecules 1,3A-B,5 in organic solvent. The electrode was then washed thoroughly to remove any non-covalent interactions. Changes to the surface morphology were consistent with ferrocene sensor molecule immobilization (FIG. 4b-c). Electrochemical studies of the 1,3B, or 5 modified electrodes showed that the Fe^{2+/3+} redox signal remained strong for over three hours. Molecule 3A with the lipoic acid linker did not show good signal or stability. However, the n=5 linker provided a the most intense and robust signal (FIG. 4d) and therefore was explored first in the work reported below.

### Method 2: Activated Carbon Electrode.

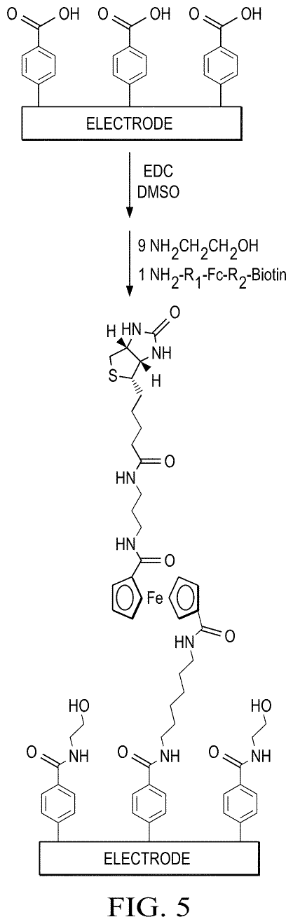

An alternative approach to immobilization is to use a graphite surface that effectively inhibits movement of molecules on the surface to form islands. Using diazonium salts, mixed monolayers can be produced as shown in FIG. 5. It has also been shown that after a carboxylic acid monolayer is deposited and activated with acids, a mixture of amines can be added to achieve groups for functionalization.

### Non-Limiting Target Enzyme Choices: Rationale

The original hypothesis which formed the basis of the present work was that enzyme activity could be used to transform a ferrocene-based sensor molecule into a new molecule that has a new Fe^{2+/3+} redox signal. The change in potential would serve as the read-out for quantifying enzyme concentrations. The laboratory work involving the exploration of the ferrocene caspase-3 sensor and the product show that this initial hypothesis is valid. A change has been observed of the E_{1/2}=˜350 mV between the ferrocene caspase-3 sensor and product molecule. Based on these results, work has been undertaken to develop new ferrocene sensor molecules to target β-galactosidase, matrix metalloprotien-2, trypsin, and chymotrypsin, enzyme targets 2-5 respectively. Rationale for each enzyme is described below.

### Target 2: Galactosidase.

β-galactosidase is a member of a family of enzymes that catalyze the hydrolysis of galactose into monosaccharides. Bacteria, fungi, parasites, and viruses utilize glycosidase enzymes as a means of survival. Therefore, the presence of glycosidase enzymes is used as a marker for pathogens or indication of disease. For example, β-galactosidase in drinking water, recreational pools, and other bodies of water indicate the presence of coliforms. Measurements of β-galactosidase have also been used to indicate E. coli and certain antibiotic resistant bacteria. Increased serum concentrations of this enzyme have also been noted in patients afflicted with colon cancer, for example. This is largely a result of cancer cells shifting metabolism and energy production away from mitochondrial activity to more glycolytic pathways. Current detection measurements rely on colorimetric methods that are subject to misinterpretation, particularly when opaque or turbid bacterial samples are used. Therefore, the β-galactosidase enzyme provides a viable target for use in the practice of the present invention.

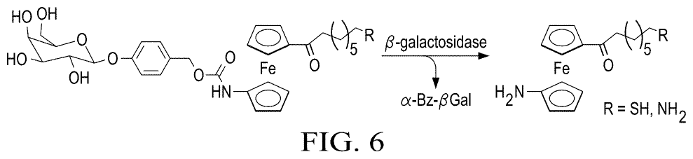

The design of these sensors will use the self-immolative benzyloxycarbamate unit to attach the galactose substrate to the ferrocene redox component. Upon enzyme cleavage of galactose, the benzyloxycarbamate rearranges and is also cleaved from the ferrocene sensor molecule to yield a free amine as shown in FIG. 6.

### Target 3: Matrix Metalloproteins.

Matrix Metalloproteins (MMP) are a member of zinc dependent proteinases. This family of enzymes is responsible for the degradation of extracellular matrix components. Although MMPs play a role in normal physiological conditions, changes to their expression have been implicated in numerous disease processes including tumor cell invasion and cancer metastasis. A direct correlation between the expression of MMPs and tumor progression in various cancer types including lung, breast, colon, prostate, skin, bladder, ovarian, and pancreatic cancer have been noted. An extensive amount of research has been carried out in order to link specific MMP varieties with specific cancer types and stages within each disease. For example, MMP-2 is expressed on the surface of invasive tumor cells and MMP-9 is associated with the conversion of radial growth phase to vertical growth phase and subsequent metastasis in melanomas. Modulations in MMP-2 levels have also been noted in the serum of patients with brain injuries as well as neurodegenerative diseases including Alzheimer's and Parkinson's. The development of ferrocene sensors specific for MMPs is particularly exciting as a tool for following the progression or neurodegeneration and measuring cancer ‘health’ as it is a known link to the stages of cancer growth or invasion. The levels of MMPs in healthy individuals would serve as a baseline for cancer patients with elevated levels of MMP-2. In other words, calibration would be essential.

In this library of ferrocene MMP-2 sensors, the SPAYYTAA peptide will be appended onto the ferrocene core using the n=5, R—SH or NH₂ linkers described in B.6. The serine amino acid will serve as the point of attachment to the redox tag. The SPAYYTAA peptide has been shown to the target of the MMP-2 enzyme resulting in a cleavage between the Tyr-Tyr dimer. The loss of the YTAA fragment is expected to shift the redox potential compared to the parent ferrocene-substrate sensor molecule.

### Targets 4-5: Trypsin and Chymotrypsin.

The enzymes trypsin and chymotrypsin are both classified as proteases which, broadly defined, carry out the hydrolysis of peptide bonds. A recent study showed that significantly higher concentrations of these enzymes were measured in the serum of patients with advanced disease stages compared to the control group. They also observed the values to decrease drastically after chemotherapy. In a separate study, increased levels of chymotrypsin were identified as a ‘powerful biomarker’ for risk stratification in hematologic malignancies. Proteases rarely act alone but rather function in a ‘protease web’. Therefore, the present work will involve the construction of independent ferrocene sensor molecules containing substrates for trypsin and chymotrypsin and immobilizing these species together in order to demonstrate the potential of multiplexing or detection of multiple enzymes simultaneously. To accomplish this, known substrates will be used: Leu-Arg-Arg is an established substrate specific for trypsin and Suc-Leu-Leu-Val-Tyr is targeted by chymotrypsin.

### Approach

### Synthesis of Ferrocene Sensor Molecules: Substrate-Ferrocene-Linker.

The following discussion will center around the development of ferrocene sensor molecules for each of the enzyme targets, as non-limiting embodiments, shown as 1-5, in Table 1). The composition of each new ferrocene sensor molecule will be: Substrate-Ferrocene-Linker as shown in FIGS. 1,6. Solid phase methods can be used to produce and isolate each new ferrocene sensor molecule. This synthetic approach consistently provides high yields and purity with little to no purification necessary and has been optimized by the inventors. An amide covalent bond will be used as the attachment point for the substrate to the ferrocene moiety in a fashion similar to that described for compound 1 (FIG. 1). The alkyl linker lengths of n=5 and linker termini of R=thiol or amine for each enzyme target will be initially explored as preliminary results with immobilization show that this provides the strongest signal with concurrent resistance to signal loss over time. However, chain lengths of n=3, 8, or 11 are straightforward alternatives. The choice of sulfur terminated linkers allows the complexes to adhere to a gold surface while those terminated with an amine will be used adhere to a carbon surface. Preliminary results (B.6) also indicate that terminus choice (R═SH and NH₂) plays a role in immobilization in chitosan films as well. Therefore, each enzyme target will be explored using two ferrocene sensor molecules varied by thiolate vs. amine termini on gold or carbon electrodes.

TABLE 1
Target enzymes, as non-limiting embodiments, selected for the
ability to consume Fc-substrate bioconjugates and produce
a new ferrocene molecule with a new electrochemical signal

| Target | Enzyme | Substrate | Control |
|---|---|---|---|
| 1 | Caspase-3 | Peptide G*DEVD | G-GEVD |
| 2 | β-galactosidase | β-Galactose | Glucose β -pyranose) |
| 3 | MMP-2 | Peptide SPAY*YTAA | SYPATAYA |
| 4 | Trypsin | Peptide LRR | GRR |
| 5 | Chymotrypsin | Peptide Suc-LLVY | Suc-GGVY |

*denotes the site of cleavage by the enzyme.
**Suc = succinamide

It is also proposed to independently synthesize the products that are predicted to be derived from the reaction of each ferrocene sensor molecule with the enzyme target of interest (examples, FIGS. 1 and 6). These products will also be produced using solid phase methods and will be the standards for the studies described below. All ferrocene sensor molecules will be characterized by H and C NMR and mass spectrometry to confirm the connectivity within each molecule. The electrochemical behavior of each new complex will be evaluated using electrochemical methods to determine the potential for the Fe^{2+/3+} redox chemistry.

### CONCLUSIONS

An invention has been provided with several advantages. The disclosed technology is advantageous over current methods because it utilizes a small sample volume and minimal sample preparation. The present technology presents an overall simple design as compared to the current approaches that use complex biological components as a part of the biosensor itself. The new design of the disclosed technology avoids signal loss, instability problems and is easily adaptable to new analytes of interest. The disclosed technology will be the first sensor molecule that can achieve detectable changes in redox potentials of the type described herein, which are orders of magnitude greater than anything in the current literature.

The presently available detection methods that are currently being used in academia and in industry research labs and not as sensitive or as effective as the disclosed technology. Although there are a range of approaches currently reported for biosensors specific to the detection of biomarkers, including enzymes, most of them use change in current as the means of quantifying an enzyme target, which results in a signal decrease. However, a decrease in signal intensity is not ideal, as it severely impedes limits of detection. The disclosed technology is a preferred detection method because it functions on a change in the redox potential (mV) of the redox tag.

A future commercial device, useful in a clinical setting, would serve as a supplement, as needed, to traditional imaging modalities by providing insight into the chemical activity of the enzymes in the patient. This approach would give physicians the opportunity to manage therapeutic strategies in response to disease related enzyme levels in a patient. The presently described unique system allows for a new signal, as opposed to the ‘turn-off’ mechanism of other biosensors, to further enhance the sensitivity.

While the invention has been shown in several of its forms, it is not thus limited but is susceptible to various changes and modifications without departing from the spirit thereof.

What is claimed is:

1. A method for detecting disease or pathogen related enzymes using electrochemical biosensors, the method comprising the steps of:
using a receptor-substrate interaction of a biosensor to provide quantifiable information about a specific analyte,
wherein the receptor-substrate interaction produces an electrical signal in the form of an observable shift in redox potential, rather than the depletion of a signal, such as current, upon interaction of the receptor with the substrate;
wherein the electrical signal so produced is used to provide quantification of disease or pathogen biomarkers in solution.

2. The method of claim 1, wherein the receptor-substrate interaction operates as an on-on mechanism, rather than as an on-off mechanism.

3. The method of claim 2, wherein the biosensor is a small, low molecular weight sensor rather than a larger peptide, RNA/DNA or an enzyme which is a part of the biosensor itself.

4. The method of claim 1, wherein a DEVD substrate with a ferrocene core is used to quantify caspase-3 enzyme in solution.

5. The method of claim 4, wherein the caspase-3 enzyme sensor produces shifts in redox potentials on the order of 300 mV and greater by enzyme action of the ferrocene sensor molecule tagged with a substrate specific for caspase-3 enzyme.

6. The method of claim 1, wherein the biosensor has three components, a linker for attachment to an electrode surface, a ferrocene signal unit comprising a ferrocene molecule and a substrate that can be removed from the ferrocene molecule.

7. The method of claim 6, wherein a highly reversible Fe^{2+/3+} redox couple of ferrocene is used as an electrochemical signal for analyte detection.

8. A method for detecting disease or pathogen related enzymes using electrochemical biosensors, the method comprising the steps of:
using a receptor-substrate interaction of a biosensor to provide quantifiable information about a specific analyte,
wherein the receptor-substrate interaction produces an observable shift in redox potential, rather than the depletion of a signal, such as current, upon interaction of the receptor with the substrate;
using the quantifiable information so obtained for disease or pathogen detection in a human body; and
wherein a ferrocene molecule tagged with a substrate specific for a particular enzyme is used as a sensor electrode which targets the specific enzyme associated with disease or pathogens.

9. The method of claim 8, wherein the specific enzymes are selected from the group consisting of caspase-3, β-galactosidase, MMP-2, trypsin and chymotrypsin.

10. The method of claim 8, wherein the ferrocene molecule which is tagged with the substrate comprises a bioconjugate, and wherein the selected enzyme has the ability to consume the ferrocene substrate bioconjugate to produce a new ferrocene molecule which has a new, detectable and measurable electrochemical signal.

11. The method of claim 8, wherein the ferrocene substrate bioconjugates are responsive to target selected enzymes to provide changes of >300 mV shifts in redox potentials.

12. The method of claim 8, wherein the receptor-substrate interaction operates as an on-on mechanism, rather than as an on-off mechanism.

13. The method of claim 8, wherein the biosensor is a small, low molecular weight sensor rather than a larger peptide, RNA/DNA or an enzyme which is a part of the biosensor itself.

14. The method of claim 8, wherein a DEVD substrate with a ferrocene core is used to quantify caspase-3 enzyme in solution.

15. The method of claim 14, wherein the caspase-3 enzyme sensor produces >300 mV shifts in redox potentials by enzyme action of the ferrocene sensor molecule tagged with a substrate specific for caspase-3 enzyme.

16. The method of claim 8, wherein the biosensor has three components, a linker for attachment to an electrode surface, a ferrocene signal unit comprising a ferrocene molecule and a substrate that can be removed from the ferrocene molecule.

17. The method of claim 8, wherein a highly reversible Fe^{2+/3+} redox couple of ferrocene is used as an electrochemical signal.

18. A method for detecting disease or pathogen related enzymes using electrochemical biosensors, the method comprising the steps of:
providing a biosensor which is responsive to reactivity of specific enzymes, the biosensor having three components, a simple linker for attachment to an electrode surface, a ferrocene molecule signal unit and a substrate than can be removed from the ferrocene molecule by enzymatic activity;
wherein a reversible Fe^{2+/3+} redox couple of the ferrocene molecule signal unit is used as an electrochemical signal that is detected and measured;
wherein the substrate is covalently attached to the ferrocene molecule that is selectively targeted and known to be cleaved by the enzyme of interest;
wherein enzyme activity acts to remove the substrate from the ferrocene molecule, thereby producing a new ferrocene molecule with a new redox potential compared to the starting ferrocene-substrate molecule;
wherein a shift in redox potential can be detected between the starting ferrocene substrate molecule and the new ferrocene molecule, the shift producing an electrical signal which is measured used to provide quantified information;
using the quantified information so obtained to analyze enzyme concentrations associated with disease or pathogens in a human body.

19. A method for detecting disease or pathogen related enzymes using electrochemical biosensors, the method comprising the steps of:
providing an optimized biosensor which has the ability to quantify a specific enzyme analyte using a receptor-substrate interaction and an on-on observable detection mechanism, rather than the depletion of a signal, such as current, as the detection mechanism, the on-on detection mechanism producing a measurable shift in redox potential which can be measured with electrochemistry; and
wherein the cyclic voltammetry measurements so obtained are used to provide quantified information which can be used for disease or pathogen detection in a human body.
